(19) United States
(12) Patent Application Publication
(10) Pub. No.: US 2026/0320695 A1
(43) Pub. Date: Oct. 15, 2026

(54) Retirement Age Generator

(71) Applicant: Christine Elane Mayfield, Jacksonville, AL (US)

(72) Inventor: Christine Elane Mayfield, Jacksonville, AL (US)

(21) Appl. No.: 19/178,475

(22) Filed: Apr. 14, 2025

(51) Int. Cl. G06Q 40/06

(52) U.S. Cl. CPC G06Q 40/066

(57) ABSTRACT

A computer-implemented method, system, and non-transitory computer-readable medium are disclosed for determining a potential retirement age based on financial inputs, without requiring a user to input a target retirement age. The system receives user inputs including current age, net worth, savings, desired retirement income, anticipated age of death, investment return rates, and inflation rate. One or more processors calculate, typically on a year-by-year basis, future required income amounts (adjusted for inflation and applicable benefits) and a total capital needed value (determined via backward iteration using present value calculations). The processors also calculate projected net worth growth (determined via forward iteration considering savings and returns). A gap between projected net worth and total capital needed is determined for each year. The processors identify an earliest age at which the projected net worth meets or exceeds the total capital needed. This identified earliest age is outputted as a calculated scenario retirement age.

### BACKGROUND OF THE INVENTION

### 1. Field of Endeavor

The present invention pertains generally to the field of computer-implemented financial planning and analysis tools. More specifically, the invention relates to methods and systems for simulating retirement scenarios, particularly focusing on calculating a potential retirement age and associated net worth based upon user-defined financial inputs and scenario parameters. This invention addresses the subject matter often classified under US patent Class 705 (Data Processing: Financial, Business Practice, Management, or Cost/Price Determination), which concerns computer systems and methods utilized in the practice, administration, or management of financial data and planning.

### 2. Description of Related Art

The field of retirement planning commonly utilizes various simulators and calculators. Many conventional tools require a user to input a predetermined target retirement date as a fundamental parameter for analysis (See, e.g., descriptions of commercially available calculators). Based on this user-specified date, along with other inputs like current assets, savings rates, and assumed market returns, these systems calculate projected financial outcomes to assess the feasibility of retiring at that specific date. Prior art systems also exist for analyzing probabilities of reaching financial goals or assessing income feasibility (See, e.g., U.S. Pat. No. 7,031,935; US 2013/0318007 A1).

However, a persistent limitation in many widely available tools is their reliance on the user pre-selecting a retirement date. This presents a challenge for individuals whose primary objective is not to validate a chosen date, but rather to determine when retirement might become financially viable based on their current financial status and future expectations. Users often seek to understand the earliest feasible retirement age achievable given variables such as their current net worth, ongoing savings contributions, desired level of income during retirement, anticipated inflation, and expected investment performance. The conventional approach forces users into a trial-and-error process or requires them to make potentially arbitrary assumptions about their retirement timeline.

The present invention is drawn towards overcoming this deficiency. Existing systems often necessitate the target retirement date as an input to derive financial projections. In contrast, the need exists for a system and method that accepts fundamental financial parameters—such as current (scenario) age, net worth, monthly savings, desired monthly retirement income, anticipated age of death, inflation rate, and distinct pre- and post-retirement investment return rates—and employs an algorithm to process these inputs to calculate and output a predicted retirement age and the corresponding net worth at that predicted age, assuming the input values hold true. This provides a direct answer to the user's underlying question of “Based on my situation, when can I retire?”. An initial conceptualization addressing this need involved a macro-enabled spreadsheet attempting to predict a retirement date based on net worth, savings, and desired income, highlighting the utility of the algorithmic approach now developed.

### SUMMARY OF THE INVENTION

It is an object of the present invention to overcome the limitations of prior art retirement planning tools that typically require a user to input a predetermined retirement date. It is a further object to provide a system and method that directly calculates a projected retirement age based on a user's specific financial parameters and desired retirement scenario.

Accordingly, the present invention provides a computer-implemented method, system, and potentially a non-transitory computer-readable medium containing instructions for calculating a potential retirement age and associated net worth.

In one aspect, a computer-implemented method comprises receiving a plurality of user-defined inputs via one or more input interfaces. These inputs characterize a financial scenario and may include, but are not limited to, a user's current (scenario) age, net worth, planned periodic savings contributions (e.g., monthly savings), a desired periodic retirement income (e.g., desired monthly retirement income), an estimated age of death, an assumed annual inflation rate, and assumed pre-retirement and post-retirement investment rates of return.

The method further comprises processing, via one or more processors executing stored instructions, the received plurality of user-defined inputs using a defined algorithm. This processing involves simulating or calculating the progression of the user's financial status over time based on the provided inputs.

Crucially, the method comprises calculating, based on the processing, a predicted retirement age at which the user's simulated financial status meets criteria associated with the desired periodic retirement income, considering the other input parameters. The method may also calculate the predicted net worth corresponding to that predicted retirement age.

Finally, the method comprises outputting, via one or more output interfaces (e.g., a display screen), the calculated predicted retirement age and, optionally, the predicted net worth.

By calculating the retirement age as a primary output derived from fundamental financial inputs, the present invention provides a significant advantage over prior art systems. It directly addresses the user's need to understand when retirement may be feasible under a given set of circumstances, rather than merely assessing the viability of an arbitrarily chosen retirement date. The invention thus offers a more intuitive and direct approach to retirement planning simulation.

### BRIEF DESCRIPTION OF DRAWINGS

The accompanying drawings, which are incorporated herein and form part of the specification, illustrate embodiments of the invention and, together with the description, further explain the principles of the invention and to enable a person skilled in the pertinent art to make and use the invention.

FIG. 1 depicts a diagram illustrating data elements utilized in this computer-implemented method according to an embodiment, including inputs, outputs, and the structure of DATA OUTPUT: SCENARIO DATA ROWS (21).

FIG. 2 COMPUTER BASED METHOD DATA FLOW AND CALCULATIONS PROCESS depicts a flowchart illustrating the top-level workflow for this computer-implemented method according to an embodiment, showing the primary flow for transforming input data to determine final output values.

FIG. 3 (100) SUB-PROCESS 1 depicts a flowchart illustrating the first primary sub-flow process (100) according to an embodiment, responsible for creating DATA OUTPUT: SCENARIO DATA ROWS (21) (referenced generally as [x1, x2 . . . xn]) and populating initial output values therein for columns, SCENARIO DATA ROW: AGE (31) and SCENARIO DATA ROW: YEAR (32).

FIG. 4 (200) SUB-PROCESS 2 depicts a flowchart illustrating the second primary sub-flow process (200) according to an embodiment, which iterates through the DATA OUTPUT: SCENARIO DATA ROWS (21) generated in the process of FIG. 3 and determines values for column SCENARIO DATA ROW: INCOME REQUIRED (34).

FIG. 5 (2100) SUB-PROCESS 2.1 depicts a flowchart illustrating the first secondary level sub-flow process (2100) according to an embodiment, executed when a first decision point (202) within the parent sub-flow process (200) evaluates to true, for calculating SCENARIO DATA ROW: INCOME REQUIRED (34) adjusted for social security.

FIG. 6 (2200) SUB-PROCESS 2.2 depicts a flowchart illustrating the second secondary level sub-flow process (2200) according to an embodiment, executed when the first decision point (202) within the parent sub-flow process (200) evaluates to false, for calculating SCENARIO DATA ROW: INCOME REQUIRED (34) without adjustments for social security or pension.

FIG. 7 (2300) SUB-PROCESS 2.3 depicts a flowchart illustrating the third secondary level sub-flow process (2300) according to an embodiment, executed when a second decision point (204) within the parent sub-flow process (200) evaluates to true, for calculating SCENARIO DATA ROW: INCOME REQUIRED (34) adjusted for pension.

FIG. 8 (300) SUB-PROCESS 3 depicts a flowchart illustrating the third primary sub-flow process (300) according to an embodiment, responsible for calculating the SCENARIO DATA ROW: TOTAL TO RETIRE (35) for each scenario data row by iterating backward and applying a present value calculation.

FIG. 9 (400) SUB-PROCESS 4 depicts a flowchart illustrating the fourth and final primary sub-flow process (400) according to an embodiment, responsible for calculating the SCENARIO DATA ROW: NET WORTH (36) and Scenario Data Row: Gap (37) for each DATA OUTPUT: SCENARIO DATA ROWS (21) by iterating forward, and for identifying the DATA OUTPUT: SCENARIO AGE TO RETIRE (22) and DATA OUTPUT: SCENARIO NET WORTH TO RETIRE (23).

FIG. 10 MOBILE MOCK-UPS 1 illustrates exemplary user interface screens for a mobile software application embodiment using this computer-implemented method, depicting screens for receiving various user inputs (1-10, in this embodiment, the system provides values for inputs 11-14) required by the calculation method, including conditional screens for social security and benefit details and a screen to initiate the calculation.

FIG. 11 MOBILE MOCK-UPS 2 depicts additional exemplary user interface screens for a mobile software application embodiment using this computer-implemented method, illustrating the presentation of output results calculated by the method and options for user interaction, such as reviewing and modifying inputs to re-trigger the method.

FIG. 12-FIG. 15 illustrates an exemplary user interface screen (actual screen shots for working prototype) for a desktop software application embodiment using this computer-implemented method. All data values shown in these screen shots are examples of potential input data that would result in the associated output data.

FIG. 12 DESKTOP PROTOTYPE SCREEN SHOT 1 illustrates an exemplary user interface screen for a desktop software application embodiment using this computer-implemented method, displaying areas for user inputs (1-14), primary calculated outputs (18, 19), and a detailed results table presenting DATA OUTPUT: SCENARIO DATA ROWS (21).

FIG. 13 DESKTOP PROTOTYPE SCREEN SHOT 2 illustrates another view of the exemplary desktop software application embodiment using this computer-implemented method user interface shown in FIG. 12, providing a detailed and enlarged view of the area displaying the DATA OUTPUT: SCENARIO DATA ROWS (21) and their constituent data points.

FIG. 14 DESKTOP PROTOTYPE DATA OUTPUT: SCENARIO DATA ROWS (21) SET OF DATA ONE displays the first set of actual DATA OUTPUT: SCENARIO DATA ROWS (12) that were generated by this computer-implemented method when the inputs shown in FIG. 12 were applied. This view includes the exact data shown in FIG. 13, but in a more readable format.

FIG. 15 DESKTOP PROTOTYPE DATA OUTPUT: SCENARIO DATA ROWS (21) SET OF DATA TWO displays the second set of actual DATA OUTPUT: SCENARIO DATA ROWS (12) that were generated by this computer-implemented method when the inputs shown in FIG. 12 were applied. This view includes the exact data shown in FIG. 13, but in a more readable format.

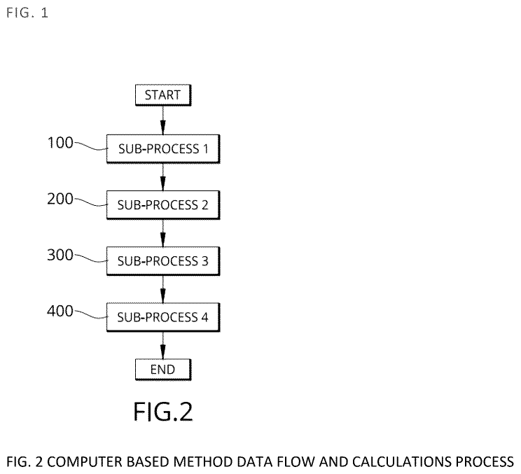

### DETAILED DESCRIPTION OF THE INVENTION

The following detailed description refers to the accompanying drawings that illustrate exemplary embodiments of the present invention. Other embodiments are possible, and modifications may be made to the embodiments described herein without departing from the spirit and scope of the invention. Therefore, the following detailed description is not meant to be limiting.

### I. System Overview and Operating Environment

Embodiments of the present invention relate to computer-implemented systems and methods for determining a potential retirement age and associated financial metrics based on user-provided financial data and assumptions. The invention may be implemented, for example, as instructions stored on a non-transitory computer-readable medium, which when executed by one or more processors, cause the processor(s) to perform the methods described herein. The system may comprise one or more processing units, memory, input/output interfaces (such as graphical user interfaces presented on displays), and communication interfaces, configured to execute the described functions.

As discussed in the Background section, conventional retirement planning tools often require a user to specify a target retirement date upfront. The present invention overcomes this limitation by providing a mechanism to calculate the retirement age as an output. The following sections describe the processes involved in achieving this outcome in accordance with various embodiments. While specific examples of user interfaces or application types (e.g., desktop or mobile applications) may be referenced for illustrative purposes, the underlying method is generally applicable across different computing platforms and architectures.

### II. High-Level Process Flow

Referring generally to the process flow illustrated conceptually in FIG. 2, an exemplary computer-implemented method for determining a user's retirement age and net worth according to an embodiment proceeds as follows:

1. Receiving User Inputs: The method initiates by receiving, typically via a user interface, a plurality of user-specific input parameters. These inputs define the user's financial situation and retirement goals and may include, without limitation: current (scenario) age, net worth, planned periodic savings (e.g., monthly savings), a desired periodic retirement income value, an anticipated age of death, an assumed annual inflation rate, and distinct pre-retirement and post-retirement investment return rates.

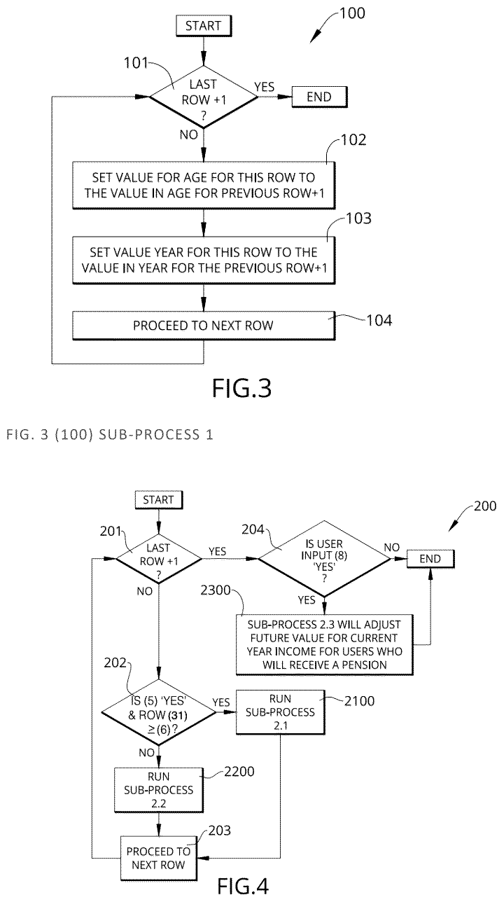

2. Generating DATA OUTPUT: SCENARIO DATA ROWS (21): Upon receiving the inputs, a processing unit executes an algorithm to generate a set of DATA OUTPUT: SCENARIO DATA ROWS (21) (referenced generally as (21) in FIG. 3). Each row typically corresponds to a specific year or age in the user's future, starting from the DATA INPUT: SCENARIO AGE (1) and extending up to the User Input: Expected DATA INPUT: DEATH AGE (13). For instance, if the DATA INPUT: SCENARIO AGE (1) is 40 and the User Input: Expected DATA INPUT: DEATH AGE (13) is 90, the system would generate 51 distinct DATA OUTPUT: SCENARIO DATA ROWS (21). This process is further detailed in the description of FIG. 3.

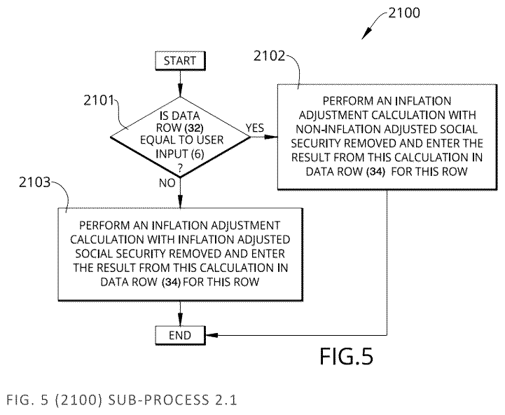

3. Calculating Future Value Income Required: After the DATA OUTPUT: SCENARIO DATA ROWS (21) are created, the algorithm proceeds to populate values for each row, including determining a SCENARIO DATA ROW: INCOME REQUIRED (34). This calculation typically involves adjusting the DATA INPUT: MONTHLY RETIREMENT INCOME (4) for factors like inflation over time. During this step, adjustments may also be incorporated for anticipated income streams such as Social Security and/or Pension benefits, if applicable to the specific age/year represented by the row. This process is associated with sub-flows detailed in FIGS. 4-7.

4. Calculating SCENARIO DATA ROW: TOTAL TO RETIRE (35): Subsequently, the method calculates Values for SCENARIO DATA ROW: TOTAL TO RETIRE (35) for each scenario data row (21). In preferred embodiments, this calculation proceeds iteratively, often starting from the row corresponding to the highest age (DATA INPUT: DEATH AGE (13)) and working progressively downwards to the row corresponding to the next highest age, and so on. The value for SCENARIO DATA ROW: TOTAL TO RETIRE (35) for a given row (representing a specific age/year) is determined based on the financial resources required to sustain the desired income (represented by the future value calculated in the previous step) from that age/year until the anticipated age of death, potentially utilizing values calculated for subsequent age/year rows. This calculation aims to define, for any given age/year, the total future-valued amount the user would need to possess at that point to fund their desired retirement income stream thereafter.

5. Determining DATA OUTPUT: SCENARIO AGE TO RETIRE (22) and DATA OUTPUT: SCENARIO NET WORTH TO RETIRE (23): The method then performs a further iteration through the DATA OUTPUT: SCENARIO DATA ROWS (21) to calculate the projected SCENARIO DATA ROW: NET WORTH (36) for each corresponding age/year, considering initial net worth, savings, and investment returns. Concurrently or subsequently, a Gap Required to support yourself (Scenario Data Row: Gap (37)) is calculated for each row, typically representing the difference between the calculated SCENARIO DATA ROW: NET WORTH (36) and the calculated SCENARIO DATA ROW: TOTAL TO RETIRE (35) for that age/year. The algorithm identifies the specific scenario data row (21) where the Gap Required to support yourself (Scenario Data Row: Gap (37)) first becomes zero or negative (indicating sufficient funds). The Age (e.g., SCENARIO DATA ROW: AGE (31)) and the calculated SCENARIO DATA ROW: NET WORTH (36) corresponding to this identified row are then designated as the primary outputs: DATA OUTPUT: SCENARIO AGE TO RETIRE (22) and DATA OUTPUT: SCENARIO NET WORTH TO RETIRE (23), respectively.

6. Outputting Results: The calculated DATA OUTPUT: SCENARIO AGE TO RETIRE (22) and DATA OUTPUT: SCENARIO NET WORTH TO RETIRE (23) are outputted, for example, presented to the user via a display or stored for reporting. In some embodiments, the complete set of DATA OUTPUT: SCENARIO DATA ROWS (21) with all calculated values may also be made available for more detailed analysis by the user.

7. Update Mechanism: In some embodiments, mechanisms may be provided to allow users to update specific inputs and efficiently recalculate the DATA OUTPUT: SCENARIO AGE TO RETIRE (22) and DATA OUTPUT: SCENARIO NET WORTH TO RETIRE (23) outputs, potentially involving manipulation or recalculation related to specific DATA OUTPUT: SCENARIO DATA ROWS (21) rather than regenerating the entire set.

8. The subsequent section will provide a more granular description of the specific calculations and logic associated with the individual figures referenced above.

### Detailed Description of FIG. 2

Referring now to FIG. 2, a flowchart illustrates a high-level overview of an exemplary computer-implemented method or processing algorithm according to an embodiment of the invention. The logical process flow initiates at a Start block and concludes at an End block, encompassing several major processing stages represented by blocks 100, 200, 300, and 400, executed sequentially in this embodiment.

The process commences and proceeds to Sub-Process 1, denoted by reference numeral 100. As previously described and detailed further in FIG. 3, this stage generally involves receiving user inputs and generating a set of scenario data structures or rows (e.g., DATA OUTPUT: SCENARIO DATA ROWS (21)), each corresponding to a future time period (e.g., year or age) within the simulation timeframe defined by the DATA INPUT: SCENARIO AGE (1) and DATA INPUT: DEATH AGE (13). Initial values, such as SCENARIO DATA ROW: AGE (31) and SCENARIO DATA ROW: YEAR (32), are typically populated within these DATA OUTPUT: SCENARIO DATA ROWS (21) during this stage.

Following the completion of Sub-Process 1 (100), the method proceeds to Sub-Process 2, denoted by reference numeral 200. This stage represents a significant phase of calculation, generally involving the determination of future value financial metrics for each scenario data row generated in stage 100. Specifically, as detailed further in FIG. 4, this stage calculates values such as the SCENARIO DATA ROW: INCOME REQUIRED (34). As indicated in FIG. 2 and detailed in subsequent figures (FIGS. 5-7), Sub-Process 2 (200) may encompass or invoke several subsidiary sub-processes, including a first secondary sub-process (2100), a second secondary sub-process (2200), and a third secondary sub-process (2300), often executed based on conditional logic evaluated during the execution of stage 200.

Upon completion of Sub-Process 2 (200), the method advances to Sub-Process 3, denoted by reference numeral 300. In this stage, the algorithm typically calculates cumulative financial requirements, such as determining the Values for SCENARIO DATA ROW: TOTAL TO RETIRE (35) for each scenario data row (21), often through an iterative process working backward from the latest time period (e.g., DATA INPUT: DEATH AGE (13)) as previously outlined.

Subsequent to Sub-Process 3 (300), the method proceeds to the final primary calculation stage, Sub-Process 4, denoted by reference numeral (400). This stage generally involves calculating the user's projected SCENARIO DATA ROW: NET WORTH (36) for each scenario data row (21) and comparing it against the calculated requirements (e.g., SCENARIO DATA ROW: TOTAL TO RETIRE (35)) to determine the Scenario Data Row: Gap (37). Based on identifying the point where this gap becomes non-positive, Sub-Process 4 (400) determines the final output values, namely the DATA OUTPUT: SCENARIO AGE TO RETIRE (22) and the corresponding DATA OUTPUT: SCENARIO NET WORTH TO RETIRE (23).

After the completion of Sub-Process 4 (400), the high-level process flow concludes, proceeding to the End block, signifying that the primary outputs have been determined and are available for presentation to the user or for storage.

### Detailed Description of FIG. 3

Referring now to FIG. 3, a flowchart illustrates the operations within Sub-Process 1 (referenced by numeral 100 in FIG. 2), according to an embodiment. This sub-process is primarily responsible for the creation and initial population of a plurality of DATA OUTPUT: SCENARIO DATA ROWS (21), wherein each row corresponds to a specific time interval (e.g., a year) within the user-defined simulation period.

The sub-process (100) initiates at a Start block and enters an iterative loop designed to process each scenario data row (21) required, from a first row representing the user's current status up to a final row corresponding to the DATA INPUT: DEATH AGE (13).

The control of this iterative process is managed by Decision block 101. At this step, a determination is made whether the processing for all required DATA OUTPUT: SCENARIO DATA ROWS (21) has been completed (e.g., checking if the next row to be processed exceeds the final required row). If the condition is met (YES path), indicating all DATA OUTPUT: SCENARIO DATA ROWS (21) have been processed, Sub-Process 1 (100) concludes and proceeds to the End block for this stage.

If the determination at Decision block 101 indicates that further DATA OUTPUT: SCENARIO DATA ROWS (21) require processing (NO path), the process proceeds to execute the steps within the loop for the current scenario data row (designated generically as row ‘[x]’).

First, at Process block 102, the value for the SCENARIO DATA ROW: AGE (31) data element is set for the current row [x]. Typically, this involves incrementing the value stored in SCENARIO DATA ROW: AGE (31) of the immediately preceding row [x−1] by one year. A conditional logic handles the initialization for the very first row, wherein the value for SCENARIO DATA ROW: AGE (31) is set based on the user-provided input value DATA INPUT: SCENARIO AGE (1). The calculation may be represented as: (31)[x]=(31)[x−1]+1 (with special handling for the first row).

Next, at Process block 103, the value for the SCENARIO DATA ROW: YEAR (32) data element is set for the current row [x]. Similar to the SCENARIO DATA ROW: AGE (31) calculation, this typically involves incrementing the value stored in SCENARIO DATA ROW: YEAR (32) of the immediately preceding row [x−1] by one year. Correspondingly, a conditional logic handles the initialization for the first row, wherein the value for SCENARIO DATA ROW: YEAR (32) is set based on a defined current year value accessible by the computer system. The calculation may be represented as: (32)[x]=(32)[x−1]+1 (with special handling for the first row).

Following the population of SCENARIO DATA ROW: AGE (31) and SCENARIO DATA ROW: YEAR (32) for the current row [x], the process logically proceeds to Step 104, which signifies advancing the iteration to the next required scenario data row. Control then returns to Decision block 101 to evaluate whether further iterations are necessary.

This iterative process continues, executing steps 102, 103, and 104 for each required scenario data row (21), until Decision block 101 determines that all DATA OUTPUT: SCENARIO DATA ROWS (21) within the simulation timeframe have been created and initially populated, at which point Sub-Process 1 (100) terminates.

### Detailed Description of FIG. 4

Referring now to FIG. 4, a flowchart illustrates the operations within Sub-Process 2 (referenced by numeral (200) in FIG. 2), according to an embodiment. This sub-process is primarily responsible for calculating the final values for SCENARIO DATA ROW: INCOME REQUIRED (34) for each scenario data row within DATA OUTPUT: SCENARIO DATA ROWS (21). This value represents the inflation-adjusted income needed for the corresponding year, incorporating adjustments based on user inputs related to social security and pension benefits. Sub-Process 200 achieves this in two distinct sequential phases. The sub-process (200) initiates at a Start block and enters the first phase, which involves an iterative loop structure designed to process each scenario data row within DATA OUTPUT: SCENARIO DATA ROWS (21) one by one to apply inflation and social security adjustments.

This first phase iteration is controlled by Decision block 201. This step determines if all required DATA OUTPUT: SCENARIO DATA ROWS (21) have been processed for this phase. If the determination at Decision block 201 indicates that further rows require processing (NO path), the process executes conditional logic for the current scenario data row [x]. Control proceeds to Decision block 202, which evaluates criteria related to the applicability of social security benefits for the current row [x] (e.g., based on DATA INPUT: SOCIAL SECURITY (5) and potentially the SCENARIO DATA ROW: AGE (31) associated with the row).

If the condition at Decision block 202 is met (YES path), subsidiary sub-process 2100 (detailed in FIG. 5) is executed to calculate an intermediate value for SCENARIO DATA ROW: INCOME REQUIRED (34) incorporating social security adjustments.

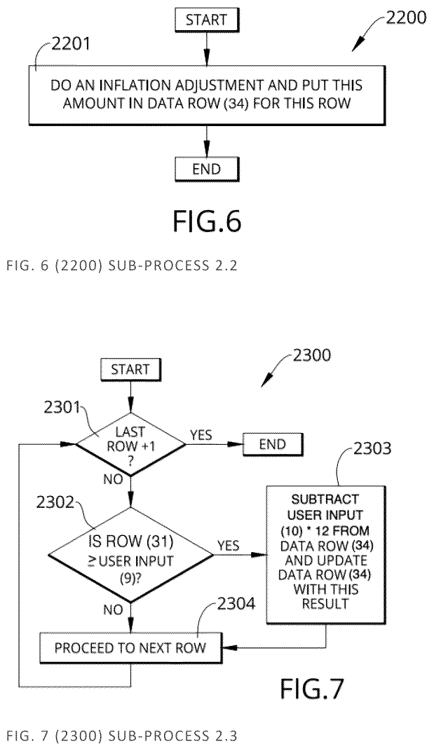

Conversely, if the condition at Decision block 202 is not met (NO path), subsidiary sub-process 2200 (detailed in FIG. 6) is executed to calculate the intermediate value for SCENARIO DATA ROW: INCOME REQUIRED (34) without social security adjustments for that row.

Following the execution of either sub-process 2100 or 2200, the process advances to the next scenario data row, facilitated by logic represented conceptually by Process block 203, returning control to Decision block 201 to evaluate the loop condition again. This first phase continues until Decision block 201 determines that all rows within DATA OUTPUT: SCENARIO DATA ROWS (21) have been processed (YES path).

Upon completion of the first phase (Decision 201=YES), the method proceeds to the second phase, initiating at Decision block 204. This decision point evaluates criteria related to the applicability of pension benefits (e.g., based on DATA INPUT: PENSION (8)).

If the condition at Decision block 204 is not met (NO path), indicating no pension adjustments are required, Sub-Process 200 concludes and proceeds to the End block.

However, if the condition at Decision block 204 is met (YES path), indicating pension adjustments are applicable, subsidiary sub-process 2300 (detailed in FIG. 7) is executed. As defined for this embodiment, sub-process 2300 performs a re-iteration through the relevant DATA OUTPUT: SCENARIO DATA ROWS (21). During this re-iteration within sub-process 2300, the SCENARIO DATA ROW: INCOME REQUIRED (34) values (as calculated in the first phase) are further adjusted for applicable pension benefits for each relevant row according to the logic detailed in FIG. 7.

Upon completion of subsidiary sub-process 2300 (if executed), the second phase is complete, and Sub-Process 200 concludes, proceeding to the End block. The final SCENARIO DATA ROW: INCOME REQUIRED (34) values within DATA OUTPUT: SCENARIO DATA ROWS (21) now reflect adjustments for inflation, social security (from phase one), and pension (from phase two, if applicable).

### Detailed Description of FIG. 5

Referring now to FIG. 5, a flowchart illustrates the operations within subsidiary sub-process 2100, according to an embodiment. This sub-process is invoked within Sub-Process 2 (200, FIG. 4) when Decision 202 evaluates to YES, typically indicating that social security benefits are applicable and require incorporation into the calculation of SCENARIO DATA ROW: INCOME REQUIRED (34) for the current scenario data row [x]. The primary purpose of sub-process 2100 is to calculate this value (SCENARIO DATA ROW: INCOME REQUIRED (34)) by adjusting the future value of the desired income to account for anticipated social security payments.

The sub-process (2100) initiates at a Start block and proceeds to Decision block 2101. This step determines the specific method for applying social security adjustments based on timing. It compares the SCENARIO DATA ROW: AGE (31) value associated with the current scenario data row [x] against the user-provided input value indicating the age at which social security benefits commence (DATA INPUT: SOCIAL SECURITY AGE (6)).

If the determination at Decision block 2101 is YES, meaning the SCENARIO DATA ROW: AGE (31) for the current row [x] is equal to DATA INPUT: SOCIAL SECURITY AGE (6), control proceeds to Process block 2102. In this step, the SCENARIO DATA ROW: INCOME REQUIRED (34) for row [x] is calculated using a non-inflation adjusted social security benefit payment DATA INPUT: SOCIAL SECURITY AMOUNT (7). This calculation typically involves determining the future value of the annualized desired income (e.g., DATA INPUT: MONTHLY RETIREMENT INCOME (4) multiplied by 12) adjusted for inflation (e.g., using DATA INPUT: INFLATION (14)) from the start of the simulation (e.g., DATA INPUT: SCENARIO AGE (1)) to the SCENARIO DATA ROW: AGE (31)[x]. From this amount, a non-inflation-adjusted annualized social security benefit amount (e.g., derived from a base monthly input like DATA INPUT: SOCIAL SECURITY AMOUNT (7), multiplied by 12) is subtracted. This reflects the scenario where the first year of social security payments may not yet include cost-of-living adjustments.

An exemplary calculation 1 may be represented as:

SCENARIO DATA ROW: INCOME REQUIRED (34)[x]=(((4)*12)*(1+(14))\hat{ }((31)[x]−(1)))−((7)*12)

Note: Assumes (4) is DATA INPUT: MONTHLY RETIREMENT INCOME (4), (14) is DATA INPUT: INFLATION (14), (1) is DATA INPUT: SCENARIO AGE (1), and (7) is DATA INPUT: SOCIAL SECURITY AMOUNT (7). Graphically, the calculation implemented by Process block 2102 is represented by:

(((4)*12))*)1+(14))\hat{ }^{((31)[x]-(1)})−(7)*12

If the determination at Decision block 2101 is NO, meaning the SCENARIO DATA ROW: AGE (31) for the current row [x] is subsequent to the DATA INPUT: SOCIAL SECURITY AGE (6) (given that entry into sub-process 2100 implies SCENARIO DATA ROW: AGE (31) is greater than or equal to DATA INPUT: SOCIAL SECURITY AGE (6)), control proceeds to Process block 2103. In this step, the SCENARIO DATA ROW: INCOME REQUIRED (34) for row [x] is calculated in a different manner. Similar to step 2102, the future value of the annualized desired income ((DATA INPUT: MONTHLY RETIREMENT INCOME (4))*12) is calculated. However, the amount subtracted represents the inflation-adjusted annualized social security benefit. This involves calculating the future value of the base annualized (DATA INPUT: SOCIAL SECURITY AMOUNT (7)*12) considering DATA INPUT: INFLATION (14) acting from DATA INPUT: SOCIAL SECURITY AGE (6) up to the SCENARIO DATA ROW: AGE (31)[x]. This reflects scenarios where subsequent years of social security payments include cost-of-living adjustments.

An exemplary calculation 2 for this condition may be represented as:

SCENARIO DATA ROW: INCOME REQUIRED (34)[x]=(((4)*12)*(1+(14))\hat{ }((31)[x]−(1)))−(((7)*12)*(1+(14))\hat{ }((31)[x]−(6))

Note: Assumes (4) is DATA INPUT: MONTHLY RETIREMENT INCOME (4), (14) is DATA INPUT: INFLATION (14), (1) is DATA INPUT: SCENARIO AGE (1), (7) is DATA INPUT: SOCIAL SECURITY AMOUNT (7), and (6) is DATA INPUT: SOCIAL SECURITY AGE (6).

Graphically, the calculation implemented by Process block 2103 is represented by:

(((4)*12))*(2+(14))\hat{ }^{((31)[x]-(1))})−(((7)*12))*(1+(14))\hat{ }^{((31)[x]-(6))})

Following the execution of either Process block 2102 or Process block 2103, the calculation of SCENARIO DATA ROW: INCOME REQUIRED (34) for the current row [x] under the conditions of this sub-process is complete. Sub-process 2100 then concludes and proceeds to the End block, returning control to the parent Sub-Process 2 (200) shown in FIG. 4.

### Detailed Description of FIG. 6

Referring now to FIG. 6, a flowchart illustrates the operations within subsidiary sub-process 2200, according to an embodiment. This sub-process is invoked within Sub-Process 2 (200, FIG. 4) when Decision 202 evaluates to NO. This condition typically signifies that for the current scenario data row [x] being processed, either the user is not expected to receive social security benefits, or the SCENARIO DATA ROW: AGE (31) associated with the current row [x] precedes the user-defined age for commencing such benefits (DATA INPUT: SOCIAL SECURITY AGE (6)) Consequently, this sub-process calculates the SCENARIO DATA ROW: INCOME REQUIRED (34) without applying adjustments for social security.

The sub-process (2200) initiates at a Start block and proceeds directly to Process block 2201. In this step, the SCENARIO DATA ROW: INCOME REQUIRED (34) for the current row [x] is calculated based solely on the user's desired income adjusted for inflation. The calculation involves determining the future value of the annualized desired income (e.g., DATA INPUT: MONTHLY RETIREMENT INCOME (4) multiplied by 12) compounded over the period from the simulation's start age (e.g., DATA INPUT: SCENARIO AGE (1)) to the age corresponding to the current row (SCENARIO DATA ROW: AGE (31)[x]), using an assumed inflation rate (e.g., DATA INPUT: INFLATION (14)). No subtraction or adjustment for social security benefits is performed in this calculation path.

An exemplary calculation may be represented as:

SCENARIO DATA ROW: INCOME REQUIRED (34)[x]=(((4)*12)*(1+(14))\hat{ }((31)[x]−(1)))

Note: Assumes (4) is DATA INPUT: MONTHLY RETIREMENT INCOME (4), (14) is DATA INPUT: INFLATION (14), and (1) is DATA INPUT: SCENARIO AGE (1).

Graphically, the calculation implemented by Process block 2201 is represented by:

(((4)*(12))*(1+(14))\hat{ }^{((20)[x]-(1))})

Following the execution of Process block 2201, the calculation of SCENARIO DATA ROW: INCOME REQUIRED (34) for the current row [x] under the conditions of this sub-process is complete. Sub-process 2200 then concludes and proceeds to the End block, returning control to the parent Sub-Process 2 (200) shown in FIG. 4.

### Detailed Description of FIG. 7

Referring now to FIG. 7, a flowchart illustrates the operations within subsidiary sub-process 2300, according to an embodiment. This sub-process is invoked within Sub-Process 2 (200, FIG. 4) when Decision 204 evaluates to YES, indicating that pension benefits are applicable and require incorporation into the calculation of SCENARIO DATA ROW: INCOME REQUIRED (34). Sub-process 2300 performs this adjustment by iterating through the relevant scenario data rows.

The sub-process (2300) initiates at a Start block and enters an iterative loop designed to process each relevant row within DATA OUTPUT: SCENARIO DATA ROWS (21).

The control of this iterative process within sub-process 2300 is managed by Decision block 2301. This step determines if all necessary rows ([x1, x2 . . . xn]) within DATA OUTPUT: SCENARIO DATA ROWS (21) have been evaluated or processed for pension adjustments during this specific execution of sub-process 2300. If the condition is met (YES path), signifying completion of this iterative adjustment phase, Sub-Process 2300 concludes and proceeds to the End block, returning control to the parent process (FIG. 4). If the determination at Decision block 2301 indicates that further rows require processing within this sub-process (NO path), control proceeds to execute conditional logic for the current scenario data row [x]. Specifically, the process advances to Decision block 2302. This step determines if pension benefits should be accounted for in the current row [x] based on timing, by comparing the SCENARIO DATA ROW: AGE (31) value associated with the current row [x] against the user-provided DATA INPUT: AT WHAT AGE WILL YOU START RECEIVING A PENSION? (9).

If the determination at Decision block 2302 is YES (meaning SCENARIO DATA ROW: AGE (31)[x] is greater than or equal to the pension start age (9)), control proceeds to Process block 2303. In this step, the value currently stored in SCENARIO DATA ROW: INCOME REQUIRED (34) for the current row [x] (having already been calculated considering inflation and potential social security in phase one of Sub-Process 200) is updated by subtracting the applicable annualized pension benefit. This annualized benefit is typically derived from the user-provided DATA INPUT: PENSION AMOUNT (10) multiplied by 12. The result of this subtraction becomes the new, pension-adjusted value for SCENARIO DATA ROW: INCOME REQUIRED (34) for the current row [x].

An exemplary calculation is:

Updated SCENARIO DATA ROW: INCOME REQUIRED (34)[x]=Current(34)[x]−((10)*12).

If the determination at Decision block 2302 is NO (meaning AGE (31)[x] precedes the pension start age (9)), then Process block 2303 is bypassed, and no pension adjustment is made to SCENARIO DATA ROW: INCOME REQUIRED (34) for this row during this iteration.

Following the conditional execution path determined by Decision 2302, the process logically proceeds to Step 2304. This step signifies advancing the iteration to the next scenario data row within DATA OUTPUT: SCENARIO DATA ROWS (21) for evaluation within sub-process 2300. Control then returns to Decision block 2301 to evaluate whether further iterations are necessary within this pension adjustment phase.

This iterative loop (controlled by 2301) continues until all relevant rows have been processed for potential pension adjustments, at which point Sub-Process 2300 terminates via the YES path from Decision 2301, returning control to the parent Sub-Process 2 (200) shown in FIG. 4.

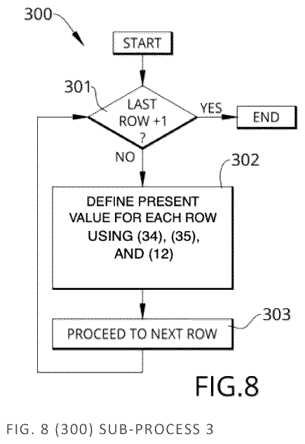

### Detailed Description of FIG. 8

Referring now to FIG. 8, a flowchart illustrates the operations within Sub-Process 3 (referenced by numeral (300) in FIG. 2), according to an embodiment. This sub-process is primarily responsible for calculating the values for SCENARIO DATA ROW: TOTAL TO RETIRE (35) for each relevant scenario data row within DATA OUTPUT: SCENARIO DATA ROWS (21). This value (35) aims to represent the capital required at the start of a given year (SCENARIO DATA ROW: YEAR) to fund the desired retirement income for that year and all subsequent years up to the DATA INPUT: DEATH AGE (13).

The sub-process (300) initiates at a Start block and employs an iterative loop structure that processes the scenario data rows within DATA OUTPUT: SCENARIO DATA ROWS (21) in reverse chronological order (backward iteration).

The control of this backward iterative process is managed by Decision block 301. This step determines if all relevant scenario data rows (e.g., iterating backward from row [xn] down to [x1]) have been processed. If the condition is met (YES path), indicating the calculation is complete for all necessary rows, Sub-Process 3 (300) concludes and proceeds to the End block.

If the determination at Decision block 301 indicates that further rows require processing in the backward sequence (NO path), the process proceeds to execute the calculation step within the loop for the current scenario data row (designated generically as row ‘[x]’).

At Process block 302, the value for SCENARIO DATA ROW: TOTAL TO RETIRE (35) is defined for the current row [x]. The method specifies a boundary condition for the final row: if the SCENARIO DATA ROW: AGE (31) for the current row [x] is equal to the DATA INPUT: DEATH AGE (13), then the SCENARIO DATA ROW: TOTAL TO RETIRE (35) for this final row [xn] is set equal to the SCENARIO DATA ROW: INCOME REQUIRED (34) (representing income required) value for that same row [xn].

For all other rows (where SCENARIO DATA ROW: AGE (31)[x] is less than DATA INPUT: DEATH AGE (13)), Process block 302 calculates the SCENARIO DATA ROW: TOTAL TO RETIRE (35) for the current row [x] based on values SCENARIO DATA ROW: INCOME REQUIRED (34) from the current row [x] and SCENARIO DATA ROW: TOTAL TO RETIRE (35) from the subsequent row [x+1], DATA INPUT: POST-RETIREMENT RETURN (12), the DATA INPUT: DEATH AGE (13), and the SCENARIO DATA ROW: AGE (31) for the current row [x] ((31)[x]).

An exemplary calculation is:

SCENARIO DATA ROW: TOTAL TO RETIRE (35)[x]=(((34)[x]+(35)[x+1])/((1+(12))\hat{ }((13)−(31)[x])))

Note: Assumes (34) is SCENARIO DATA ROW: INCOME REQUIRED (34), (35) is SCENARIO DATA ROW: TOTAL TO RETIRE (35), (12) is DATA INPUT: INFLATION (12), (13) is DATA INPUT: SCENARIO AGE (13), [x] is the current row being evaluated, and [x+1] is the row for the subsequent year from the current row year.

Graphically, the calculation implemented by Process block 302 is represented by:

$$( \frac{( 34 ) [ x ] + ( 35 ) [ x + 1 ]}{( 1 + ( 12 ) ) \hat{} ( ( 13 ) - ( 31 ) [ x ] )} )$$

Formula Explanation based on provided structure: The numerator sums the income required during the year corresponding to row [x] and the capital needed at the start of the year corresponding to row [x+1]. The denominator calculates a discount factor by compounding the DATA INPUT: POST-RETIREMENT RETURN (12) over the number of years remaining from the SCENARIO DATA ROW: AGE (31) of the current row [x] until DATA INPUT: DEATH AGE (13). The result of this calculation is stored as the SCENARIO DATA ROW: TOTAL TO RETIRE (35) for the current row [x].

Following the calculation at Process block 302, the process logically proceeds to Step 303, which signifies advancing the iteration to the previous scenario data row in the sequence (e.g., decrementing the row index from x to x−1). Control then returns to Decision block 301 to evaluate whether further iterations are necessary in this backward pass.

This iterative loop (controlled by 301) continues until all relevant rows have been processed with the outcome being the population of the calculated SCENARIO DATA ROW: TOTAL TO RETIRE (35) for each scenario data row within DATA OUTPUT: SCENARIO DATA ROWS (21), at which point Sub-Process 300 terminates via the YES path from Decision 301, returning control to the parent Process (400) shown in FIG. 2.

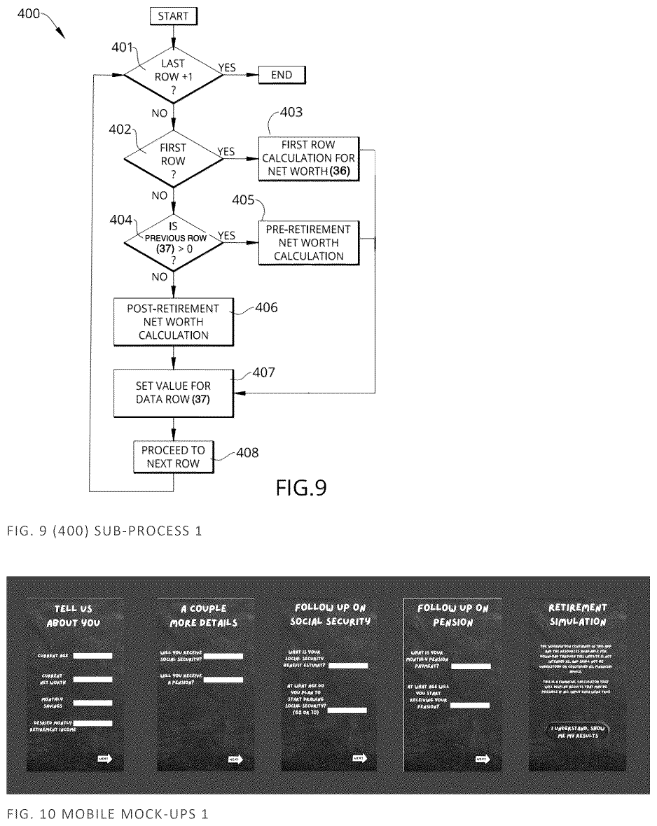

### Detailed Description of FIG. 9

Referring now to FIG. 9, a flowchart illustrates the operations within Sub-Process 4 (referenced by numeral (400) in FIG. 2), according to an embodiment. This sub-process is primarily responsible for calculating, for each DATA OUTPUT: SCENARIO DATA ROWS (21), the projected SCENARIO DATA ROW: NET WORTH (36) and the SCENARIO DATA ROW: GAP (37). Furthermore, this sub-process identifies the primary outputs of the overall method, namely the DATA OUTPUT: SCENARIO AGE TO RETIRE (22) and the corresponding DATA OUTPUT: SCENARIO NET WORTH TO RETIRE (23), based on analyzing the calculated gap.

The sub-process (400) initiates at a Start block and enters an iterative loop structure designed to process each DATA OUTPUT: SCENARIO DATA ROWS (21) in chronological order, typically based on the row's SCENARIO DATA ROW: AGE (31).

The control of this iterative process is managed by Decision block 401. This step determines if all required DATA OUTPUT: SCENARIO DATA ROWS (21) have been processed. If the condition is met (YES path), indicating completion, Sub-Process 4 (400) concludes and proceeds to the End block for this stage. If the determination at Decision block 401 indicates that further DATA OUTPUT: SCENARIO DATA ROWS (21) require processing (NO path), the process executes a sequence of steps for the current scenario data row (designated generically as row ‘[x]’). First, control proceeds to Decision block 402, which checks if the current row [x] is the first row in the sequence.

If the condition at Decision block 402 is YES, indicating it is the first row, control proceeds to Process block 403. In this step, the SCENARIO DATA ROW: NET WORTH (36) for the first row [x] is initialized using the value provided by the user as DATA INPUT: SCENARIO NET WORTH (2).

An exemplary calculation is:

SCENARIO DATA ROW: NET WORTH (36)[x]=DATA INPUT: SCENARIO NET WORTH (2)

Additionally, within Process block 403 for the first row, the SCENARIO DATA ROW: GAP (37) is also calculated based on the initialized net worth and the previously calculated total needed for that row (SCENARIO DATA ROW: TOTAL TO RETIRE (35)[x]).

An exemplary calculation is:

SCENARIO DATA ROW: GAP (37)[x]=SCENARIO DATA ROW: NET WORTH (36)[x]−SCENARIO DATA ROW: TOTAL TO RETIRE (35)[x]

From process block 403, the flow continues directly to process block 408.

If the condition at Decision block 402 is NO, indicating it is a subsequent row (not the first row), control proceeds to Decision block 404.

Decision block 404: This step checks whether the current row [x] represents a pre-retirement or post-retirement year. This may be based on the value in SCENARIO DATA ROW: GAP (37) from the previous row [x−1].

If the condition at Decision block 404 is YES, (indicating the SCENARIO DATA ROW: GAP (37) from the previous row [x−1] is greater than 0), control proceeds to Process block 405. Here, the SCENARIO DATA ROW: NET WORTH (36) for the current row [x] is calculated using DATA INPUT: PRE-RETIREMENT RETURN (11) rate.

This typically involves taking the SCENARIO DATA ROW: NET WORTH (36) from the previous row [x−1], adding investment returns based on the applicable rate (DATA INPUT: PRE-RETIREMENT RETURN (11) rate), and adding any planned annual savings contributions (DATA INPUT: MONTHLY SAVINGS (3)).

An exemplary representation is:

SCENARIO DATA ROW: NET WORTH (36)[x]=((36)[x−1]*(1+(11)))+(3)

Note: Assumes (36) is SCENARIO DATA ROW: NET WORTH (36), (11) is DATA INPUT: PRE-RETIREMENT RETURN (11), (3) is DATA INPUT: MONTHLY SAVINGS (3), [x] is the current row being evaluated, and [x+1] is the row for the subsequent year from the current row year.

If the condition at Decision block 404 is NO, (indicating the SCENARIO DATA ROW: GAP (37) from the previous row [x−1] is less than 0), control proceeds to Process block 406. In this process block, SCENARIO DATA ROW: NET WORTH (36) for the current row [x] is calculated using DATA INPUT: POST-RETIREMENT RETURN (12) rate.

This typically involves taking the SCENARIO DATA ROW: NET WORTH (36) from the previous row [x−1], adding investment returns based on the applicable rate (DATA INPUT: POST-RETIREMENT RETURN (12) rate), this time not adding any planned annual savings contributions (DATA INPUT: MONTHLY SAVINGS (3)).

An exemplary representation is:

SCENARIO DATA ROW: NET WORTH (36)[x]=((36)[x−1]*(1+(12)))

Note: Assumes (36) is SCENARIO DATA ROW: NET WORTH (36), (12) is DATA INPUT: POST-RETIREMENT RETURN (12), [x] is the current row being evaluated, and [x+1] is the row for the subsequent year from the current row year.

As a part two of Process block 406, there is a check to determine if this is the first occurrence where SCENARIO DATA ROW: GAP (37) is greater than 0. If this is true, the values for DATA OUTPUT: SCENARIO AGE TO RETIRE (22) and DATA OUTPUT: SCENARIO NET WORTH TO RETIRE (23) are set from values from this current row.

An exemplary representation is:

DATA OUTPUT: SCENARIO AGE TO RETIRE (22)=SCENARIO DATA ROW: AGE (31)[x]

DATA OUTPUT: SCENARIO NET WORTH TO RETIRE (23)=SCENARIO DATA ROW: NET WORTH (36)[x]

Following the calculation of SCENARIO DATA ROW: NET WORTH (36)[x] in either Process block 405 or 406, control proceeds to Process block 407. In this step, the SCENARIO DATA ROW: GAP (37) for the current row [x] is calculated This is typically determined by subtracting the SCENARIO DATA ROW: TOTAL TO RETIRE (35)[x] (calculated in Sub-Process 3 (300), FIG. 8) from the calculated SCENARIO DATA ROW: NET WORTH (36)[x] for the current row,

An exemplary calculation is:

SCENARIO DATA ROW: GAP (37)[x]=SCENARIO DATA ROW: NET WORTH (36)[x]−SCENARIO DATA ROW: TOTAL TO RETIRE (35)[x]

Next, at Process block 408, the iteration moves to continue to the next row.

This iterative process continues, executing steps for each DATA OUTPUT: SCENARIO DATA ROWS (21), until Decision block 401 determines that all DATA OUTPUT: SCENARIO DATA ROWS (21) have been processed, at which point Sub-Process 4 (400) terminates. The final determined DATA OUTPUT: SCENARIO AGE TO RETIRE (22) and DATA OUTPUT: SCENARIO NET WORTH TO RETIRE (23) are then available as the primary results of the overall method.

Following the calculation at Process block 407, the process logically proceeds to Step 408, which signifies advancing the iteration to the previous scenario data row in the sequence (e.g., decrementing the row index from x to x−1). Control then returns to Decision block 401 to evaluate whether further iterations are necessary in this backward pass.

This iterative loop (controlled by 401) continues until all relevant rows have been processed with the outcome being the population of the calculated SCENARIO DATA ROW: NET WORTH (36), and SCENARIO DATA ROW: GAP for each scenario data row within DATA OUTPUT: SCENARIO DATA ROWS (21), as well as DATA OUTPUT: SCENARIO AGE TO RETIRE (22) DATA OUTPUT: SCENARIO NET WORTH TO RETIRE (23) for this method, and at which point Sub-Process 400 terminates via the YES path from Decision 401, returning control to the parent Process (400) shown in FIG. 2.

Following return to the parent process (400), the entire data workflow is terminated as all steps have been completed.

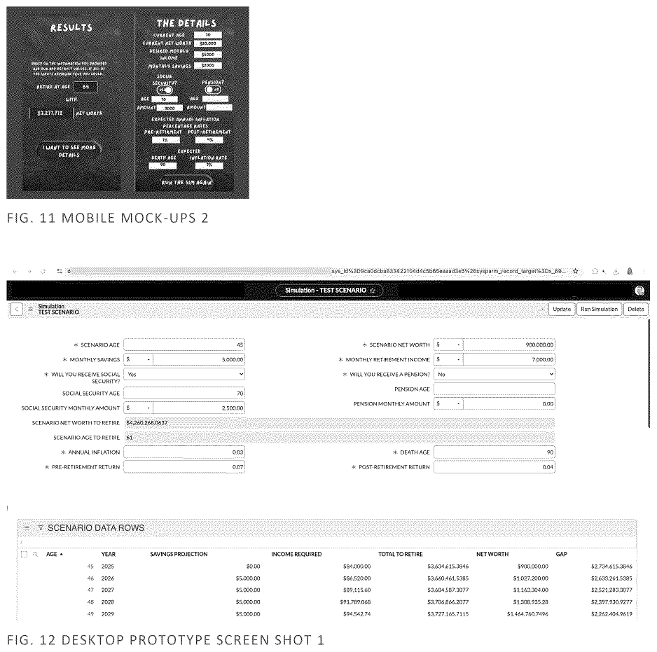

### Detailed Description of FIG. 10

Referring now to FIG. 10, this figure depicts representations of exemplary user interface screens or views suitable for implementation in a software application, such as a mobile application, embodying the computer-implemented method of the invention. These screens illustrate an exemplary workflow for receiving the various user input variables utilized by the algorithm previously described (FIGS. 2-9). A first exemplary input screen, designated Screen 1, is configured to receive fundamental user financial data. This screen may present input fields for acquiring values corresponding to DATA INPUT: SCENARIO AGE (1), DATA INPUT: SCENARIO NET WORTH (2), DATA INPUT: MONTHLY SAVINGS (3), and DATA INPUT: MONTHLY RETIREMENT INCOME (4).

A second exemplary input screen, designated Screen 2, is configured to receive user information regarding anticipated retirement benefits. This screen may present input elements (e.g., selection buttons, checkboxes) for acquiring Boolean or affirmative/negative values corresponding to DATA INPUT: SOCIAL SECURITY (5) and DATA INPUT: PENSION (8).

A third exemplary input screen, designated Screen 3, may be conditionally displayed to the user. Its display is predicated on the user providing an affirmative indication for DATA INPUT: SOCIAL SECURITY (5) via Screen 2. If displayed, Screen 3 presents input fields for acquiring further details related to social security, corresponding to DATA INPUT: SOCIAL SECURITY AGE (6), and DATA INPUT: SOCIAL SECURITY AMOUNT (7).

A fourth exemplary input screen, designated Screen 4, may also be conditionally displayed. Its display is predicated on the user providing an affirmative indication for DATA INPUT: PENSION (8) via Screen 2. If displayed, Screen 4 presents input fields for acquiring further details related to the pension, corresponding to DATA INPUT: PENSION AGE (9), and DATA INPUT: PENSION AMOUNT (10).

A fifth exemplary screen, designated Screen 5, may serve multiple purposes. It may display important information to the user, such as a disclaimer clarifying the nature of the simulation and recommending consultation with a financial advisor. Furthermore, Screen 5 may include a user-activatable control element (e.g., a button labeled “Calculate,” “Run Simulation,” or similar) which, when activated by the user, initiates the execution of the computer-implemented calculation method detailed in FIGS. 2-9 using the input values gathered via Screens 1-4.

These exemplary screens represent one possible embodiment for a user interface facilitating the input of necessary data for the described retirement calculation method. Other arrangements and combinations of input screens or interface elements may also be employed.

### Detailed Description of FIG. 11

Referring now to FIG. 11, this figure illustrates further exemplary user interface screens or views, following potentially from the input screens depicted in FIG. 10, suitable for implementation in a software application embodying the invention. These screens focus on presenting the calculated results to the user and facilitating further interaction.

A first exemplary results screen, designated Screen 1 in FIG. 11, is configured to display the primary output values generated by the computer-implemented method after execution. This screen presents the calculated DATA OUTPUT: SCENARIO AGE TO RETIRE (22) and the corresponding DATA OUTPUT: SCENARIO NET WORTH TO RETIRE (23) to the user. Additionally, Screen 1 may include interactive elements, such as a button or link, allowing the user to optionally navigate to a view displaying the specific input data values that were used to generate these presented results.

A second exemplary interaction screen, designated Screen 2 in FIG. 11, provides functionality for users to review and modify the parameters of the simulation. This screen is configured to display the various input variables previously entered by the user along with system default variables used for this method (e.g., User Inputs 1-10, System inputs 11-14 etc.). Screen 2 further provides means for the user to edit or update one or more of these displayed input variables. Furthermore, Screen 2 typically includes a user-activatable control element (e.g., a “Recalculate” or “Re-run Simulation” button) that allows the user to re-initiate the execution of the computer-implemented algorithm using the current set of (potentially modified) input variables. Upon activation of this control and subsequent completion of the recalculation, the application may be configured to automatically navigate the user back to the first results screen (Screen 1 of FIG. 11) to present the newly calculated output values (22, 23).

### Detailed Description of FIG. 12

Referring now to FIG. 12, this figure illustrates an exemplary graphical user interface (GUI) screen layout for a desktop software application embodying the computer-implemented method, according to one embodiment. This screen serves as a primary interface for user interaction, data input, and results presentation.

The interface screen shown in FIG. 12 comprises several distinct regions. A first region is dedicated to displaying and receiving User Inputs. This region includes input fields corresponding to the variables utilized by the invention's algorithm, such as: DATA INPUT: SCENARIO AGE (1), DATA INPUT: SCENARIO NET WORTH (2), DATA INPUT: MONTHLY SAVINGS (3), DATA INPUT: MONTHLY RETIREMENT INCOME (4), DATA INPUT: SOCIAL SECURITY (5), DATA INPUT: SOCIAL SECURITY AGE (6), DATA INPUT: SOCIAL SECURITY AMOUNT (7), DATA INPUT: PENSION (8), DATA INPUT: PENSION AGE (9), DATA INPUT: PENSION AMOUNT (10), DATA INPUT: PRE-RETIREMENT RETURN (11), DATA INPUT: POST-RETIREMENT RETURN (12), DATA INPUT: DEATH AGE (13), and DATA INPUT: INFLATION (14).

A second region of the interface screen is configured to display the primary System Outputs generated by the method. This region presents the calculated results, specifically the DATA OUTPUT: SCENARIO AGE TO RETIRE (22) and the DATA OUTPUT: SCENARIO NET WORTH TO RETIRE (23).

A third region, potentially presented as a table, grid, or list view, displays the detailed DATA OUTPUT: SCENARIO DATA ROWS (21). This provides a year-by-year (or age-by-age) breakdown of the simulation results generated based on the input values. For each row displayed in this region, corresponding to a specific age/year, values for various calculated data points are presented. These data points may include, for example: SCENARIO DATA ROW: AGE (31), SCENARIO DATA ROW: YEAR (32), SCENARIO DATA ROW: SAVINGS PROJECTION (33), SCENARIO DATA ROW: INCOME REQUIRED (34), SCENARIO DATA ROW: TOTAL TO RETIRE (35), SCENARIO DATA ROW: NET WORTH (36) (e.g., at end of year), and SCENARIO DATA ROW: GAP (37).

Furthermore, the user interface embodiment depicted in FIG. 12 facilitates interactivity. Users may modify the values within the input fields (1-14) and subsequently re-initiate the execution of the computer-implemented method (e.g., via representation button shown “Run Simulation” or similar). Upon recalculation, the interface updates the displayed System Outputs (22, 23) and the contents of the DATA OUTPUT: SCENARIO DATA ROWS (21) in the detailed results area.

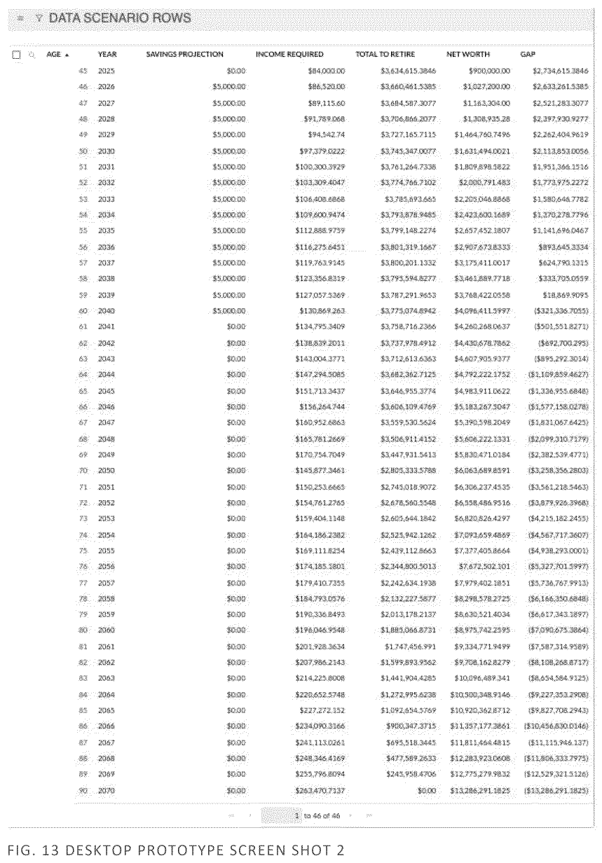

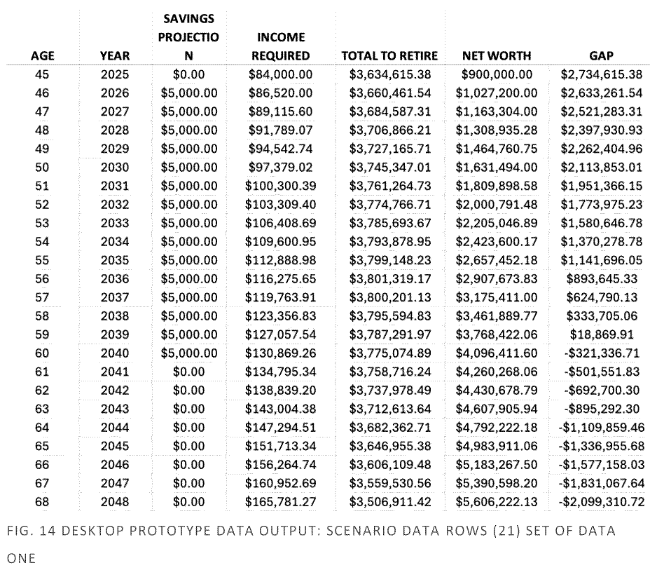

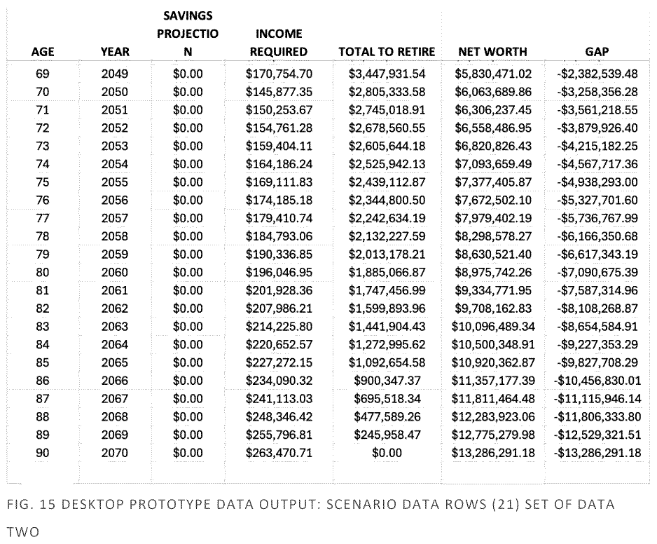

### Detailed Description of FIG. 13

Referring now to FIG. 13, this figure illustrates another view or aspect of the exemplary desktop application user interface introduced in FIG. 12. Specifically, FIG. 13 provides a more detailed, enlarged, or focused view of the third region described in FIG. 12—the area dedicated to displaying the DATA OUTPUT: SCENARIO DATA ROWS (21).

This detailed view emphasizes the tabular or list-based presentation of the year-by-year simulation results. As shown, this portion of the interface presents the calculated values corresponding to each row (representing a specific age or year) for the constituent data points generated or utilized by the method. These data points include, but are not limited to: SCENARIO DATA ROW: AGE (31), SCENARIO DATA ROW: YEAR (32), SCENARIO DATA ROW: SAVINGS PROJECTION (33), SCENARIO DATA ROW: INCOME REQUIRED (34), SCENARIO DATA ROW: TOTAL TO RETIRE (35), SCENARIO DATA ROW: NET WORTH (36), and SCENARIO DATA ROW: GAP.

FIG. 13 thus serves to illustrate more clearly how the detailed, row-level output data generated by the algorithm can be presented to the user for review and analysis within this exemplary desktop application embodiment.

What is claimed is:

1. A computer-implemented method for determining a retirement age, the method comprising: receiving, via one or more input interfaces of a computing system, a plurality of user-defined financial inputs, the inputs comprising at least a DATA INPUT: SCENARIO AGE (1), DATA INPUT: SCENARIO NET WORTH (2), a periodic savings amount (DATA INPUT: MONTHLY SAVINGS (3)), a desired periodic DATA INPUT: MONTHLY RETIREMENT INCOME (4), an anticipated DATA INPUT: DEATH AGE (13), a DATA INPUT: PRE-RETIREMENT RETURN (11) rate, a DATA INPUT: POST-RETIREMENT RETURN (12), and an DATA INPUT: INFLATION (14), wherein the plurality of user-defined financial inputs does not include a target retirement age specified by a user; generating, by one or more processors of the computing system, a plurality of DATA OUTPUT: SCENARIO DATA ROWS (21), each row corresponding to a future time period between the DATA INPUT: SCENARIO AGE (1) and the anticipated DATA INPUT: DEATH AGE (13); calculating, by the one or more processors for each DATA OUTPUT: SCENARIO DATA ROWS (21), a future value required income (SCENARIO DATA ROW: INCOME REQUIRED (34)) based at least in part on the desired periodic DATA INPUT: MONTHLY RETIREMENT INCOME (4) and the DATA INPUT: INFLATION (14); calculating, by the one or more processors for each DATA OUTPUT: SCENARIO DATA ROWS (21) by iterating backward from the anticipated DATA INPUT: DEATH AGE (13), a total capital needed value (SCENARIO DATA ROW: TOTAL TO RETIRE (35)), wherein the total capital needed value (SCENARIO DATA ROW: TOTAL TO RETIRE (35)) for a current row is based at least in part on the future value required income (SCENARIO DATA ROW: INCOME REQUIRED (34)) and the total capital needed value (SCENARIO DATA ROW: TOTAL TO RETIRE (35)) associated with a subsequent row, discounted by the DATA INPUT: POST-RETIREMENT RETURN (12); calculating, by the one or more processors for each DATA OUTPUT: SCENARIO DATA ROWS (21) by iterating forward from the DATA INPUT: SCENARIO AGE (1), a projected SCENARIO DATA ROW: NET WORTH (36) based at least in part on the DATA INPUT: SCENARIO NET WORTH (2), the periodic savings amount (DATA INPUT: MONTHLY SAVINGS (3)), and at least one of the DATA INPUT: PRE-RETIREMENT RETURN (11) or the DATA INPUT: POST-RETIREMENT RETURN (12); determining, by the one or more processors for each DATA OUTPUT: SCENARIO DATA ROWS (21), a gap value (SCENARIO DATA ROW: GAP (37)) based on a difference between the projected SCENARIO DATA ROW: NET WORTH (36) and the total capital needed value (SCENARIO DATA ROW: TOTAL TO RETIRE (35)) for that row; identifying, by the one or more processors, a specific DATA OUTPUT: SCENARIO DATA ROWS (21) corresponding to an earliest future time period where the determined gap value (SCENARIO DATA ROW: GAP (37)) meets a predefined criterion indicating financial sufficiency for retirement; deriving, by the one or more processors, a DATA OUTPUT: SCENARIO AGE TO RETIRE (22) based on the identified specific DATA OUTPUT: SCENARIO DATA ROWS (21); and outputting, via one or more output interfaces of the computing system, the derived DATA OUTPUT: SCENARIO AGE TO RETIRE (22).

2. The method of claim 1, wherein the plurality of user-defined financial inputs further comprises inputs indicating applicability of social security benefits (5, 6, 7) and pension benefits (8, 9, 10).

3. The method of claim 2, wherein calculating the future value required income (SCENARIO DATA ROW: INCOME REQUIRED (34)) for each DATA OUTPUT: SCENARIO DATA ROWS (21) further comprises conditionally adjusting the future value required income (SCENARIO DATA ROW: INCOME REQUIRED (34)) based on the inputs indicating applicability of social security benefits (5, 6, 7) and pension benefits (8, 9, 10) for the future time period corresponding to that DATA OUTPUT: SCENARIO DATA ROWS (21).

4. The method of claim 1, wherein calculating the projected SCENARIO DATA ROW: NET WORTH (36) for a current DATA OUTPUT: SCENARIO DATA ROWS (21) utilizes the DATA INPUT: PRE-RETIREMENT RETURN (11) rate if an SCENARIO DATA ROW: AGE (31) corresponding to the current DATA OUTPUT: SCENARIO DATA ROWS (21) is less than the DATA OUTPUT: SCENARIO AGE TO RETIRE (22), and utilizes the DATA INPUT: POST-RETIREMENT RETURN (12) rate otherwise.

5. The method of claim 1, wherein the predefined criterion indicating financial sufficiency for retirement is the gap value (SCENARIO DATA ROW: GAP (37)) being less than or equal to zero.

6. The method of claim 1, further comprising outputting, via the one or more output interfaces, a DATA OUTPUT: SCENARIO NET WORTH TO RETIRE (23) corresponding to the projected SCENARIO DATA ROW: NET WORTH (36) of the identified specific DATA OUTPUT: SCENARIO DATA ROWS (21).

7. The method of claim 1, further comprising storing the plurality of DATA OUTPUT: SCENARIO DATA ROWS (21), including the calculated future value required income (SCENARIO DATA ROW: INCOME REQUIRED (34)), total capital needed value (SCENARIO DATA ROW: TOTAL TO RETIRE (35)), projected SCENARIO DATA ROW: NET WORTH (36), and gap value (SCENARIO DATA ROW: GAP (37)) for each row, in memory accessible by the one or more processors.

8. A system for determining a retirement age, the system comprising: one or more input interfaces configured to receive a plurality of user-defined financial inputs, the inputs comprising at least a DATA INPUT: SCENARIO AGE (1), DATA INPUT: SCENARIO NET WORTH (2), a periodic savings amount (DATA INPUT: MONTHLY SAVINGS (3)), a desired periodic DATA INPUT: MONTHLY RETIREMENT INCOME (4), an anticipated DATA INPUT: DEATH AGE (13), DATA INPUT: PRE-RETIREMENT RETURN (11) rate, a DATA INPUT: POST-RETIREMENT RETURN (12) rate, and an DATA INPUT: INFLATION (14), wherein the plurality of user-defined financial inputs does not include a target retirement age specified by a user; one or more processors communicatively coupled to the one or more input interfaces; and a memory communicatively coupled to the one or more processors, the memory storing instructions that, when executed by the one or more processors, cause the one or more processors to perform operations comprising: generating a plurality of DATA OUTPUT: SCENARIO DATA ROWS (21), each row corresponding to a future time period between the DATA INPUT: SCENARIO AGE (1) and the anticipated DATA INPUT: DEATH AGE (13); calculating for each DATA OUTPUT: SCENARIO DATA ROWS (21), a future value required income (SCENARIO DATA ROW: INCOME REQUIRED (34)) based at least in part on the desired periodic DATA INPUT: MONTHLY RETIREMENT INCOME (4) and the DATA INPUT: INFLATION (14); calculating for each DATA OUTPUT: SCENARIO DATA ROWS (21) by iterating backward from the anticipated DATA INPUT: DEATH AGE (13), a total capital needed value (SCENARIO DATA ROW: TOTAL TO RETIRE (35)), wherein the total capital needed value (SCENARIO DATA ROW: TOTAL TO RETIRE (35)) for a current row is based at least in part on the future value required income (SCENARIO DATA ROW: INCOME REQUIRED (34)) and the total capital needed value (SCENARIO DATA ROW: TOTAL TO RETIRE (35)) associated with a subsequent row, discounted by the DATA INPUT: POST-RETIREMENT RETURN (12) rate; calculating for each DATA OUTPUT: SCENARIO DATA ROWS (21) by iterating forward from the DATA INPUT: SCENARIO AGE (1), a projected SCENARIO DATA ROW: NET WORTH (36) based at least in part on the DATA INPUT: SCENARIO NET WORTH (2), the periodic savings amount (DATA INPUT: MONTHLY SAVINGS (3)), and at least one of the DATA INPUT: PRE-RETIREMENT RETURN (11) rate or the DATA INPUT: POST-RETIREMENT RETURN (12) rate; determining for each DATA OUTPUT: SCENARIO DATA ROWS (21), a gap value (SCENARIO DATA ROW: GAP (37)) based on a difference between the projected SCENARIO DATA ROW: NET WORTH (36) and the total capital needed value (SCENARIO DATA ROW: TOTAL TO RETIRE (35)) for that row; identifying a specific DATA OUTPUT: SCENARIO DATA ROWS (21) corresponding to an earliest future time period where the determined gap value (SCENARIO DATA ROW: GAP (37)) meets a predefined criterion indicating financial sufficiency for retirement; deriving a DATA OUTPUT: SCENARIO AGE TO RETIRE (22) based on the identified specific DATA OUTPUT: SCENARIO DATA ROWS (21); and causing output, via one or more output interfaces, of the derived DATA OUTPUT: SCENARIO AGE TO RETIRE (22).

9. The system of claim 8, wherein the instructions for calculating the total capital needed value, SCENARIO DATA ROW: TOTAL TO RETIRE (35), comprise instructions for initializing the total capital needed value, SCENARIO DATA ROW: TOTAL TO RETIRE (35), to zero for a DATA OUTPUT: SCENARIO DATA ROWS (21), corresponding to the anticipated DATA INPUT: DEATH AGE (13) before initiating the backward iteration.

10. The system of claim 8, wherein the instructions for calculating the projected SCENARIO DATA ROW: NET WORTH (36) comprise instructions for initializing the projected SCENARIO DATA ROW: NET WORTH (36) for a first DATA OUTPUT: SCENARIO DATA ROWS (21) corresponding to the DATA INPUT: SCENARIO AGE (1) based on the DATA INPUT: SCENARIO NET WORTH (2).

11. The system of claim 8, wherein the predefined criterion indicating financial sufficiency for retirement is the SCENARIO DATA ROW: GAP (37) value being less than or equal to zero, and wherein the instructions for identifying the specific DATA OUTPUT: SCENARIO DATA ROWS (21) comprise instructions for identifying the first DATA OUTPUT: SCENARIO DATA ROWS (21) encountered during the forward iteration for which the SCENARIO DATA ROW: GAP (37) value is less than or equal to zero.

12. A non-transitory computer-readable medium storing instructions that, when executed by one or more processors of a computing system, cause the one or more processors to perform a method for determining a retirement age, the method comprising: receiving a plurality of user-defined financial inputs, the inputs comprising at least a DATA INPUT: SCENARIO AGE (1), DATA INPUT: SCENARIO NET WORTH (2), a periodic savings amount (DATA INPUT: MONTHLY SAVINGS (3)), a desired periodic DATA INPUT: MONTHLY RETIREMENT INCOME (4), an anticipated DATA INPUT: DEATH AGE (13), a DATA INPUT: PRE-RETIREMENT RETURN (11) rate, a DATA INPUT: POST-RETIREMENT RETURN (12) rate, and a DATA INPUT: INFLATION (14) rate, wherein the plurality of user-defined financial inputs does not include a target retirement age specified by a user; generating a plurality of DATA OUTPUT: SCENARIO DATA ROWS (21), each row corresponding to a future time period between the DATA INPUT: SCENARIO AGE (1) and the anticipated DATA INPUT: DEATH AGE (13); calculating for each DATA OUTPUT: SCENARIO DATA ROWS (21), a future value required income (SCENARIO DATA ROW: INCOME REQUIRED (34)) based at least in part on the desired periodic DATA INPUT: MONTHLY RETIREMENT INCOME (4) and the DATA INPUT: INFLATION (14) rate; calculating for each DATA OUTPUT: SCENARIO DATA ROWS (21) by iterating backward from the anticipated DATA INPUT: DEATH AGE (13), a total capital needed value (SCENARIO DATA ROW: TOTAL TO RETIRE (35)), wherein the total capital needed value (SCENARIO DATA ROW: TOTAL TO RETIRE (35)) for a current row is based at least in part on the future value required income (SCENARIO DATA ROW: INCOME REQUIRED (34)) and the total capital needed value (SCENARIO DATA ROW: TOTAL TO RETIRE (35)) associated with a subsequent row, discounted by the DATA INPUT: POST-RETIREMENT RETURN (12) rate; calculating for each DATA OUTPUT: SCENARIO DATA ROWS (21) by iterating forward from the DATA INPUT: SCENARIO AGE (1), a projected SCENARIO DATA ROW: NET WORTH (36) based at least in part on the DATA INPUT: SCENARIO NET WORTH (2), the periodic savings amount (DATA INPUT: MONTHLY SAVINGS (3)), and at least one of the DATA INPUT: PRE-RETIREMENT RETURN (11) rate or the DATA INPUT: POST-RETIREMENT RETURN (12) rate; determining for each DATA OUTPUT: SCENARIO DATA ROWS (21), a gap value (SCENARIO DATA ROW: GAP (37)) based on a difference between the projected SCENARIO DATA ROW: NET WORTH (36) and the total capital needed value (SCENARIO DATA ROW: TOTAL TO RETIRE (35)) for that row; identifying a specific scenario data row (DATA OUTPUT: SCENARIO DATA ROWS (21)) corresponding to an earliest future time period where the determined gap value (Scenario Data Row: Gap (37)) meets a predefined criterion indicating financial sufficiency for retirement; deriving a scenario retirement age (DATA OUTPUT: SCENARIO AGE TO RETIRE (22)) based on the identified specific scenario data row (DATA OUTPUT: SCENARIO DATA ROWS (21)); and outputting the derived scenario retirement age (DATA OUTPUT: SCENARIO AGE TO RETIRE (22)).
